(19) United States
(12) Patent Application Publication
(10) Pub. No.: US 2019/0236305 A1
(43) Pub. Date: Aug. 1, 2019

(54) DETECTING UNAUTHORIZED USE OF SENSITIVE INFORMATION IN CONTENT COMMUNICATED OVER A NETWORK

(71) Applicant: International Business Machines Corporation, Armonk, NY (US)

(72) Inventors: Spyridon Antonatos, Dublin (IE); Stefano Braghin, Blanchardstown (IE); Naoise Holohan, Dublin (IE); Pol Mac Aonghusa, Carbury (IE)

(21) Appl. No.: 15/882,583

(22) Filed: Jan. 29, 2018

(51) Int. Cl. G06F 21/62; G06F 21/10; G06F 17/30

(52) U.S. Cl. CPC G06F 21/6245; G06F 21/10; H04L 43/04; G06F 2221/0737; G06F 17/30864

(57) ABSTRACT

Techniques facilitating automatically detecting unauthorized use of sensitive information in content communicated over a network are provided. A computer-implemented method can comprise receiving, by a system operatively coupled to a processor, from a first entity, data associated with the first entity and one or more rules defining use of the data by a second entity. The data and the one or more rules can be defined by the first entity. The computer-implemented method can also comprise analyzing, by the system, content communicated over a network by the second entity to determine whether the content violates the one or more rules. The computer-implemented method can further comprise generating, by the system, information indicative of one or more violations of the one or more rules based on a determination that the content violates the one or more rules.

### BACKGROUND

The subject disclosure relates to monitoring data communicated over a network, and more specifically, to detecting unauthorized use of sensitive information in content communicated over a network.

### SUMMARY

The following presents a summary to provide a basic understanding of one or more embodiments of the invention. This summary is not intended to identify key or critical elements, or delineate any scope of the different embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate detecting unauthorized use of sensitive information in content communicated over a network are described.

According to an embodiment, a system can comprise a memory that stores computer executable components and a processor that executes the computer executable components stored in the memory. The computer executable components can comprise a database component that can receive, from a first entity, data associated with the first entity and one or more rules defining use of the data by a second entity. The data and the one or more rules can be defined by the first entity. The computer executable components can further comprise a monitoring component that can analyze content communicated, over a network, by the second entity, to determine whether the content violates the one or more rules. In addition, the computer executable components can also comprise a notification component that can generate information indicative of one or more violations of the one or more rules based on a determination by the monitoring component that the content violates the one or more rules.

According to another embodiment, a computer-implemented method can comprise receiving, by a system operatively coupled to a processor, from a first entity, data associated with the first entity and one or more rules defining use of the data by a second entity. The data and the one or more rules can be defined by the first entity. The computer-implemented method can also comprise analyzing, by the system, content communicated, over a network, by the second entity, to determine whether the content violates the one or more rules. The computer-implemented method can further comprise generating, by the system, information indicative of one or more violations of the one or more rules based on a determination that the content violates the one or more rules.

According to a further embodiment, a computer program product that facilitates detecting unauthorized use of data associated with an entity is provided. The computer program product can comprise a computer readable storage medium having program instructions embodied therewith, the program instructions can be executable by a processing component to cause the processing component to receive, from a first entity, data associated with the first entity and one or more rules defining use of the data by a second entity. The data and the one or more rules can be defined by the first entity. The program instructions can also cause the processing component to analyze content communicated, over a network, by the second entity, to determine whether the content violates the one or more rules. Further, the program instructions can cause the processing component to generate information indicative of one or more violations of the one or more rules based on a determination that the content violates the one or more rules.

### DESCRIPTION OF THE DRAWINGS

FIG. 1 illustrates a block diagram of an example, non-limiting system that facilitates detecting unauthorized use of sensitive information in content communicated over a network in accordance with one or more embodiments of the disclosed subject matter.

FIG. 2 illustrates a block diagram of another example, non-limiting system that facilitates detecting unauthorized use of sensitive information in content communicated over a network in accordance with one or more embodiments of the disclosed subject matter.

FIG. 3 illustrates a block diagram of another example, non-limiting system that facilitates detecting unauthorized use of sensitive information in content communicated over a network in accordance with one or more embodiments of the disclosed subject matter.

FIG. 4 illustrates a block diagram of another example, non-limiting system that facilitates detecting unauthorized use of sensitive information in content communicated over a network in accordance with one or more embodiments of the disclosed subject matter.

FIG. 5 illustrates a non-limiting example of information in the database component including example data and rules in accordance with one or more embodiments of the disclosed subject matter.

FIG. 6 illustrates an example of a block diagram employed to describe an example of authorized use of data in accordance with one or more embodiments of the disclosed subject matter.

FIG. 7 illustrates an example of a block diagram employed to describe an example of unauthorized use of data in accordance with one or more embodiments of the disclosed subject matter.

FIG. 8 illustrates a flow diagram of an example, non-limiting computer-implemented process that detects unauthorized use of sensitive information in content communicated over a network in accordance with one or more embodiments of the disclosed subject matter.

FIG. 9 illustrates a flow diagram of another example, non-limiting computer-implemented process that detects unauthorized use of sensitive information in content communicated over a network in accordance with one or more embodiments of the disclosed subject matter.

FIG. 10 illustrates a flow diagram of another example, non-limiting computer-implemented process that detects unauthorized use of sensitive information in content communicated over a network in accordance with one or more embodiments of the disclosed subject matter.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

Today computer networks, such as the Internet, for example, are frequently utilized to transmit, receive, process, track, or otherwise manage sensitive data associated with a specific entity (e.g., a client entity), which the entity does not want known or used by other entities without permission. However, third-party entities, such as advertisers or product and service providers, for example, often have a financial incentive to obtain or use an entity's sensitive data. At present, many third-party entities can successfully implement various online algorithms, technologies, or techniques (e.g., online behavioral advertising systems) to obtain or use a specific entity's sensitive data without the entity's knowledge or consent. Consequently, the entity's sensitive data can quickly propagate across the Internet without the entity's knowledge or approval. Given the increasing pervasiveness and complexity of the technology and techniques employed online by various third-party entities to obtain or use a specific entity's sensitive data without the entity's knowledge or consent, it is extremely difficult to effectively and efficiently detect unauthorized use of sensitive information in content communicated over a network.

Disclosed herein are systems, computer-implemented methods, apparatus and/or computer program products that can facilitate effectively, efficiently, and automatically (e.g., without direct participation from a human) detecting unauthorized use of sensitive information in content communicated over a network. Detecting unauthorized use of sensitive information in content communicated over a network is an important component in protecting an entity's confidentiality, and further, such detection is an important component in an entity's passive and active strategies for protecting the entity's confidentiality.

One or more embodiments can be implemented, customized, and/or maintained by an entity (e.g., a client entity), without involvement from another entity (e.g., a server entity). For example, an entity can deploy the subject disclosure utilizing a client computing device to facilitate detecting unauthorized use of the entity's sensitive information in content, such as advertisements, communicated over the Internet by third-party entities, such as product or service providers.

As referenced herein, an “entity” can be one or more computers, the Internet, one or more systems, one or more commercial enterprises, one or more computer programs, one or more machines, machinery, one or more actors, one or more users, one or more customers, one or more humans, and so forth, hereinafter referred to as an entity or entities depending on the context. Further, as utilized herein, a “third-party entity” can be one or more entity other than the principal entities involved in, for example, a transaction, agreement, exchange, communication, negotiation, partnership, and the like.

In addition, as referred to herein, “use” of sensitive information with regard to various embodiments of the subject disclosure can include, but is not limited to, direct use, indirect use, possession, possession by inference, and/or use by inference. For example, “possession by inference” and/or “use by inference” can involve an entity (e.g., a third-party entity) tracking the activity of another entity (e.g., a client entity) on the Internet, then inferring certain sensitive information (e.g., the client entity's interests or preferences) based on the entity's online activity, and then generating content (e.g., an advertisement) based on the inferred sensitive information. Further, “possession” of sensitive information, as referenced herein, can include legitimate possession (e.g., acquired from an entity authorized to possess and/or use the sensitive information) and/or illegitimate possession (e.g., acquired from an entity not authorized to possess and/or use the sensitive information). As an example, according to multiple implementations, “illegitimate possession” can involve an entity that is not authorized to possess a client entity's sensitive information obtaining the client entity's sensitive information from another entity that is authorized to possess the sensitive information.

Further, as utilized herein, the term “communicated” can include, but is not limited to, generating, transmitting, receiving, processing, tracking, rendering, conveying, imparting, sharing, exchanging, submitting, revealing, advertising, manifesting, spreading, connecting, and/or otherwise managing data between one or more entities and one or more other entities, via direct, indirect, local, and/or remote channels, as described herein. According to several embodiments discussed herein, the term “communicated” can also include, but is not limited to, rendering content in a web browser, in an electronic mail (e-mail), and/or in a social network platform, for example. By way of illustration, not limitation, the term “communicated” can include an entity (e.g., a third-party entity) rendering content in a web browser on another entity device (e.g., a client device), rendering content in an e-mail retrieved by another entity device (e.g., a client device), and/or rendering content in an online social network platform and/or environment that can be accessed by another entity device (e.g., a client device). Consequently, although various embodiments of the subject disclosure are described in association with online advertisements rendered in a web browser, it should be appreciated that the subject disclosure is not so limited. For example, in several embodiments discussed herein, the subject disclosure can analyze content associated with and/or rendered in an electronic mail (e-mail) retrieved by a recipient entity device (e.g., a client device). In another implementation, the subject disclosure can analyze content associated with an entity that is rendered in an online social network platform and/or environment that can be accessed by the entity device (e.g., a client device).

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

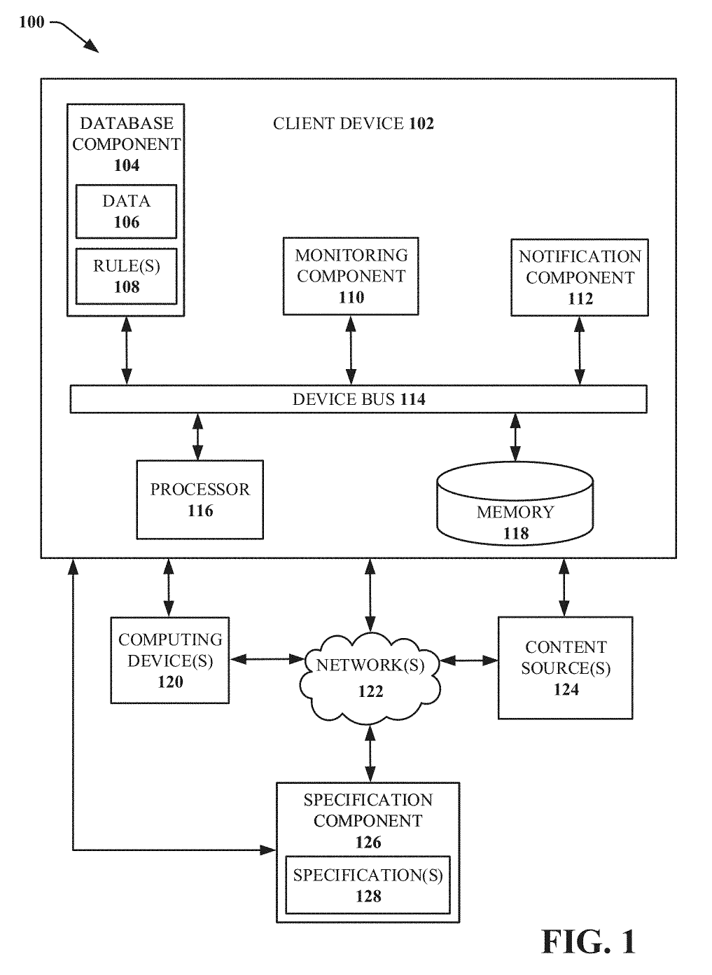

Turning now to the drawings, FIG. 1 illustrates a block diagram of an example, non-limiting system 100 that facilitates detecting unauthorized use of sensitive information in content communicated over a network in accordance with one or more embodiments of the disclosed subject matter. In the embodiment shown in FIG. 1, the system 100 can comprise client device 102 in communication with one or more computing devices 120, one or more networks 122, one or more content sources 124 and/or specification component 126.

Aspects of systems, apparatuses, or processes explained in this disclosure (e.g., the system 100 and the like) can constitute machine-executable component(s) embodied within machine(s), for example, embodied in one or more computer readable mediums (or media) associated with one or more machines. Such component(s), when executed by the one or more machines, for example, computer(s), computing device(s), virtual machine(s), and/or the like, can cause the machine(s) to perform the operations described herein. For example, the system 100 presented in FIG. 1 can include the client device 102 and associated components (e.g., database component 104, monitoring component 110, notification component 112, etc.) that can respectively correspond to machine-executable components. The system 100 can also include various electronic data sources and/or data structures (e.g., the database component 104, the content sources 124, the specification component 126) comprising information that can be read by, used by, and/or generated by the client device 102 and associated components (e.g., the monitoring component 110, the notification component 112, etc.).

The client device 102 illustrated in FIG. 1 can include database component 104, monitoring component 110, notification component 112, device bus 114, processor 116, and/or memory 118. In some embodiments, one or more of the database component 104, the monitoring component 110, the notification component 112, the processor 116, and/or the memory 118, can be communicatively, electrically, and/or operatively coupled to one another via the device bus 114, for example, to perform one or more functions of the system 100 and/or the client device 102. The memory 118 can store computer executable components and instructions (e.g., the database component 104, the monitoring component 110, the notification component 112, etc.) that when executed by the processor 116, can facilitate performance of operations defined by the executable instruction. In some embodiments, the memory 118 can also store the various data sources and/or structures of system 100 (e.g., the database component 104, the content sources 124, the specification component 126, etc.). In other embodiments, the various data sources and structures of system 100 can be stored in other memory (e.g., at a remote device or system), that is accessible to the client device 102 (e.g., via the one or more networks 122).

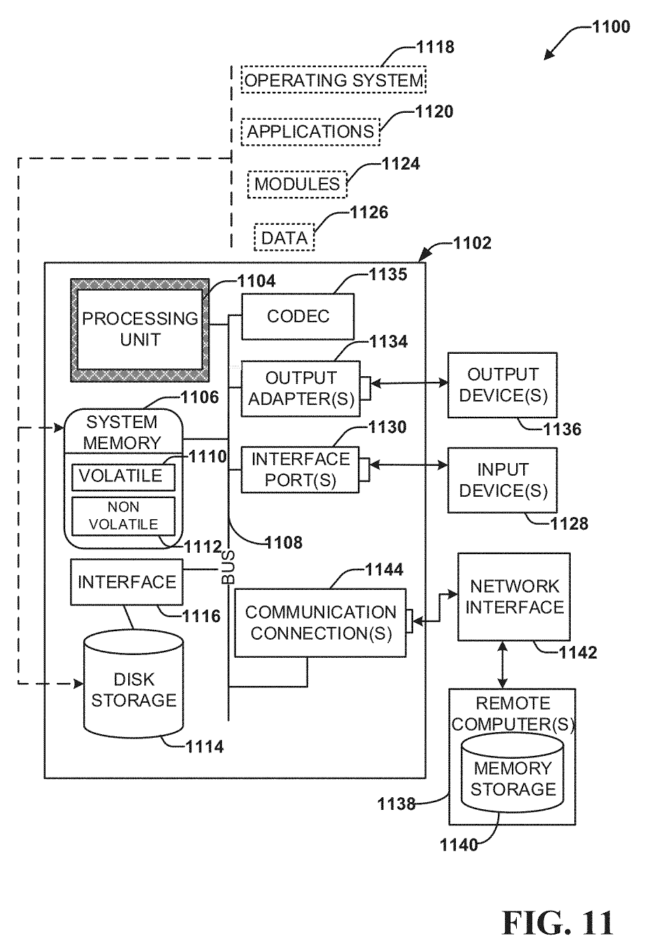

Examples of the device bus 114, the processor 116, and the memory 118, as well as other suitable computer and/or computing-based elements, can be found with reference to FIG. 11, and can be used in connection with implementing one or more of the systems and/or components shown and described in connection with FIG. 1 or other figures disclosed herein. For instance, the system 100 and/or the client device 102 can include and/or be coupled with (e.g., communicatively, electrically, operatively, etc.) various computer hardware and/or software components, such as input/output components (e.g., a mouse, a keyboard, a display monitor, one or more speakers, etc.), an operating system, and/or one or more software applications suitable for implementing one or more of the systems and/or components shown and described in connection with FIG. 1 or other figures disclosed herein.

According to several embodiments, the database component 104 can be any type of database and/or data structure (e.g., spreadsheet, database table, database index, hash table, etc.) suitable for receiving and/or storing the data 106 and/or the one or more rules 108. Further, the database component 104 can be generated, populated, modified, and/or manipulated by an entity (e.g., a client entity). For example, although not depicted in FIG. 1, the client device 102 can include and/or be coupled with (e.g., communicatively, electrically, operatively, etc.) various hardware and/or software components that can provide for generating, populating, modifying, manipulating, and/or reviewing the database component 104 (e.g., input/output components, an operating system, and/or one or more suitable software applications, such as EXCEL®, NUMBERS®, etc.). In such an example, an entity (e.g., a client entity) can employ the client device 102 and/or the associated components described above to generate, populate, modify, and/or manipulate the database component 104 (e.g., via a spreadsheet application, such as EXCEL®).

In multiple illustrations, the data 106 can include, but is not limited to, various sensitive data related to an entity, which the entity wants to safeguard from others or otherwise manage the use thereof by others (e.g., data related to an entity's identity, citizenship, health, finances, interests, preferences, etc.). Further, as described above, “use” of sensitive data related to an entity can include, but is not limited to, direct use, indirect use, possession, possession by inference, and/or use by inference. For example, “possession by inference” and/or “use by inference” can involve an entity (e.g., a third-party entity) tracking the activity of another entity (e.g., a client entity) on the Internet, then inferring certain sensitive information (e.g., the client entity's interests or preferences) based on the entity's online activity, and then generating content (e.g., an advertisement) based on the inferred sensitive information.

According to various implementations, the data 106 can be defined (e.g., generated, populated, modified, manipulated, reviewed, etc.) by an entity (e.g., a client entity, a server entity, etc.). For example, by utilizing the client device 102 and/or the hardware/software components described above (e.g., input/output components, operating system, spreadsheet software, etc.), a client entity can define the data 106 by generating the database component 104 and further electing and/or inputting to the database component 104 the data 106 (e.g., one or more data items related to the entity's identity, citizenship, health, finances, interests, preferences, etc.). In some embodiments, the client entity can be a machine, a device, a human or any component that can dictate and/or specify one or more of the data 106 and/or rules 108.

The rules 108 can include, but are not limited to, various associations, classifications, definitions, designations, instructions, and the like, for governing use of the data 106 by other entities (e.g., third-party entities not related to the data 106). For example, the rules 108 can indicate how specific data 106 is to be handled, protected or otherwise accessed in order to protect and/or maintain particular data 106 confidential. As the data 106 can be related to an entity (e.g., a client entity) and the rules 108 can govern the use of the data 106, then it follows that the rules 108 can also be related to such an entity.

According to various illustrations, the rules 108 can be defined (e.g., generated, populated, modified, manipulated, reviewed, etc.) by an entity (e.g., a client entity, a server entity, etc.). For example, by utilizing the client device 102 and/or the hardware/software components described above (e.g., input/output components, operating system, spreadsheet software, etc.), a client entity can define the rules 108 by generating the database component 104 and further electing and/or inputting to the database component 104 the rules 108. In one example, a client entity can define the rules 108 by electing and/or inputting to the database component 104 one or more sensitivity level designations (e.g., “sensitive,” “not sensitive,” etc.), one or more use designation (e.g., “can be used,” “cannot be used,” etc.), one or more content entity designations (e.g., “all,” “all others,” “hospitals,” etc.), and/or other suitable designations and/or instructions. In such an example, the client entity can further define the rules 108 by associating the one or more designations with one another and/or with the data 106 data item(s). For instance, by using a spreadsheet application (e.g., EXCEL®, NUMBERS®, etc.) to generate and/or define the data 106 and/or the rules 108, the client entity can associate the one or more designations with the data 106 data item(s) by inputting such designations in one or more cells located in the same row(s) (and/or column(s)) containing the data 106 data item(s).

According to one embodiment, a client entity can define the data 106 by electing and/or inputting to the database component 104 a data item (e.g., “cancer”). In this example, the client entity can also define the rules 108 by electing and/or inputting to the database component 104 a sensitivity level designation (e.g., “sensitive”), a use designation (e.g., “can be used”), and/or a content entity designation (e.g., “hospitals”). The client entity can further associate such designations with the data item “cancer.” According to this illustration, a client entity can define the data 106 and/or the rules 108 such that the “cancer” data item is sensitive but can be used by hospitals.

According to multiple implementations, the data 106 and/or the rules 108 can be defined (e.g., as described above) by the entity related to and/or associated with the data 106 and/or the rules 108 (e.g., a client entity). In other examples, the data 106 and/or the rules 108 can be defined (e.g., as described above) by an entity that is not related to and/or associated with the data 106 and/or the rules 108 (e.g., a server entity). For example, a server entity can generate and/or define (e.g., as described above) the database component 104, the data 106, and/or the rules 108 using data related to a client entity. In yet another embodiment, the data 106 and/or rules 108 can be generated and/or defined by one or more artificial intelligence (AI) components that can infer information identifying the data 106 and/or rules 108.

In several illustrations, access to (e.g., to generate, populate, modify, manipulate, review, etc.) the database component 104, the data 106, and/or the rules 108 can be exclusive to the entity related to and/or associated with the data 106 and/or the rules 108 (e.g., a client entity). For example, access can be restricted to only particular entities.

To implement such access control features, and thereby facilitate such exclusive access according to several examples, the client device 102 can include and/or be coupled with (e.g., communicatively, electrically, operatively, etc.) various hardware and/or software components that can facilitate such access control. Examples of such hardware and/or software components can include, but are not limited to, input/output devices (e.g., a mouse, a keyboard, a display monitor, a biometric authentication device, etc.), an operating system, and/or software suitable to provision the client device 102, the database component 104, the data 106, and/or the rules 108 with one or more access control features (e.g., a spreadsheet application, biometric authentication software, encryption/decryption application, Network Access Control (NAC) software, firewall application, etc.). In some embodiments, the database component 104 can be accessed via authentication of the client entity or entity upon receipt of login and/or password credentials.

According to one embodiment, the database component 104, the data 106, and/or the rules 108 can be included in the client device 102 itself (e.g., as depicted in FIG. 1) and/or stored in the memory 118. In such an example, access to the client device 102 and/or the memory 118, and therefore, access to the database component 104, the data 106, and/or the rules 108 can be protected, for example, via one or more access control features inherent to the operating system (e.g., access control features provided by and/or implemented by the operating system, such as password protection). In other examples, access to the client device 102 and/or the memory 118, and therefore, access to the database component 104, the data 106, and/or the rules 108 can be protected by other suitable access control components including, but not limited to, biometric authentication, Network Access Control (NAC), and/or the like. Additionally or alternatively, according to another example, an entity (e.g., a client entity) can employ the client device 102 including and/or operatively coupled with the various hardware and/or software components described above to utilize access control and/or editing protection features inherent to the spreadsheet application employed by the client device 102 (e.g., the various access control and/or editing protection features provided by and/or implemented by EXCEL®).

According to other implementations, the database component 104, the data 106, and/or the rules 108 can be stored at various external and/or remote locations (e.g., with respect to the client device 102) that can be accessible to the client device 102 and/or the monitoring component 110 via a direct connection or via the networks 122. For example, the database component 104, the data 106, and/or the rules 108 can be located at a suitable external and/or remote storage device that is accessible to the client device 102 and/or the monitoring component 110 via a direct connection or via the networks 122. In this example, access to such storage device, and therefore, access to the database component 104, the data 106, and/or the rules 108 can be protected utilizing various access control features associated with and/or inherent to the external and/or remote device employed and/or the direct connection or network connection implemented (e.g., password protection, encryption/decryption, firewall protection, Network Access Control (NAC), etc.). By implementing such access control features (e.g., via the client device 102, the networks 122, etc.), the system 100 can facilitate protected and/or exclusive access to the database component 104, the data 106, and/or the rules 108 (e.g., access can be exclusive to the entity related to and/or associated with the data 106 and/or the rules 108, such as a client entity).

In multiple examples, the one or more content sources 124 can include, but are not limited to, any online third-party entity, such as various product, service, or information providers (e.g., nonprofit entities, commercial entities, organizations, communities, institutions, etc.), advertising or marketing companies (e.g., companies hired to create or distribute advertisements), advertisement publishers (e.g., companies that publish advertisements on their websites), advertisement brokers (e.g., search engine companies), social network platforms, server computing devices and/or applications, and the like. The content communicated by the content sources 124 can include, but is not limited to, advertisements, search engine query results, and/or social network media (e.g., content generated by the social network platform administrator and/or content generated by other social network users, such as postings, image tags, user-to-user messages, etc.). Additionally or alternatively, the content communicated by the content sources 124 can include, but is not limited to, any of a variety of user interfaces (e.g., graphical user interface (GUI), form-based interface, natural language interface, etc.) that can comprise various types of media (e.g., text, image, audio, video, animation, etc.).

In various implementations, the monitoring component 110 can facilitate analyzing content communicated by the content sources 124 over the networks 122 to determine whether the content violates the rules 108. To facilitate analyzing the content according to several embodiments, the monitoring component 110 can comprise and/or employ various techniques described below to extract one or more data entities from the content, derive one or more logical inferences about the extracted data entities, and/or match the one or more extracted data entities and/or the one or more derived logical inferences to the data 106 and/or the rules 108. In some embodiments, the monitoring component 110 can analyze any and/or all discrete types of media included in the content according to the nature of the media (e.g., text, image, audio, video, animation, etc.). For example, in some embodiments, the monitoring component 110 can comprise and/or employ image recognition/classification techniques to label each image with one or more categories. In other embodiments, the monitoring component 110 can comprise and/or employ topic modeling (e.g., Latent Dirichlet Allocation), name entity recognition, and/or the like, to extract textual information from the content. According to several embodiments, the monitoring component 110 can employ a semantic reasoner over the semantic concepts extracted from the images to derive one or more logical inferences about the content. In some embodiments, the monitoring component 110 can use a hash function to process the semantic concepts to hashed values, and thereby facilitate comparing and/or matching the semantic concepts to the data 106 and/or the rules 108. All such embodiments are envisioned and are described below.

In some embodiments, to facilitate such analysis according to several embodiments, the monitoring component 110 can comprise and/or be coupled with (e.g., communicatively, electrically, operatively, etc.) various content capturing aspects (not illustrated in FIG. 1) that can be employed via the client device 102 to capture content communicated by the content sources 124 over the networks 122. Examples of such content capturing aspects can include, but are not limited to, hardware and/or software components that can facilitate webpage capturing, screen recording, screenshot capturing, and/or the like (e.g., software applications, such as “FireShot Pro,” “IceCream Screen Recorder,” PAGE VAULT BROWSER®, etc.). For instance, webpage capturing software can facilitate capturing various types of data associated with and/or rendered on a website (e.g., via copying the underlying webpage source code to one or more suitable digital files and/or storage component, such as the memory 118). By utilizing webpage capturing software and/or other suitable content capturing components, the monitoring component 110 can facilitate capturing various types of data associated with and/or rendered on a website including, but not limited to the website URL (Uniform Resource Locator), metadata, source code, hyperlinks, images, video, text, audio, animation, and/or the like.

To facilitate capturing content communicated by the content sources 124 according to multiple embodiments, the client device 102 and/or the monitoring component 110 can include and/or be coupled with (e.g., communicatively, electrically, operatively, etc.) various hardware and/or software components, such as a mouse, a keyboard, a display monitor, an operating system, a web browser application (e.g., FIREFOX®), and/or webpage capturing software. In such an example, an entity (e.g., a client entity) can utilize the client device 102, the monitoring component 110, and/or the associated components described above to navigate to a website URL (e.g., via a web browser application on the client device 102). Continuing with such an example, the client device 102 and/or the monitoring component 110 can facilitate capturing any and/or all of the various types of data associated with and/or rendered on the website as described above (e.g., via implementing webpage capturing software).

To further facilitate analyzing content communicated by the content sources 124 over the networks 122, the monitoring component 110 can include and/or be coupled with (e.g., communicatively, electrically, operatively, etc.) various data extracting aspects (not illustrated in FIG. 1) that can provide for identifying and/or extracting one or more data entities from the content communicated by the content sources 124. As referenced herein, the term “extract” can be used to describe, for example, extracting, identifying, categorizing, and/or classifying data entities included in content communicated by the content sources 124. The term “data entities” can include, but is not limited to, discrete attributes of the media contained within the content (e.g., image objects, text characters, audio wave characteristics, image pixels, image characteristics, video, video frames, etc.) and/or discrete units of metadata associated with and/or embedded in the content (e.g., descriptive metadata, structural metadata, administrative metadata, etc.).

Examples of data extracting aspects the monitoring component 110 can comprise and/or be coupled with can include, but are not limited to, hardware, software, and/or algorithms related to natural language processing, named-entity recognition, image processing, object recognition, audio recognition, speech recognition, machine learning models, and/or the like. For example, the monitoring component 110 can employ a deep learning model (e.g., a convolutional neural network) to facilitate teaching the monitoring component 110 to identify and/or extract one or more distinct data entities from the content captured by the monitoring component 110. To facilitate employing (e.g., via developing and/or deploying) a deep learning model according to multiple embodiments, the client device 102 and/or the monitoring component 110 can include and/or be coupled with (e.g., communicatively, electrically, operatively, etc.) various hardware and/or software components. Examples of such hardware and/or software components can include, but are not limited to, a mouse, a keyboard, a display monitor, an operating system, and/or other hardware and/or software suitable to develop and/or deploy a deep learning model (e.g., a graphics processing unit, a web browser application, a spreadsheet application, digital feature capturing software, and/or machine learning software, such as MATLAB® and/or other suitable software that can provide for analyzing data, developing algorithms, and/or generating mathematical models).

In one example, an entity (e.g., a client entity) can utilize the client device 102, the monitoring component 110, and/or the associated components described above (e.g., input/output components, operating system, software, etc.) to develop and/or deploy a deep learning model (e.g., a convolutional neural network). In such an example, by utilizing a deep learning model, such as a convolutional neural network, the monitoring component 110 can learn to identify and/or extract one or more distinct data entities (e.g., discrete objects in an image, discrete words, discrete metadata, etc.) from the content captured by the monitoring component 110. For instance, the monitoring component 110 can learn to identify and/or extract one or more discrete objects (e.g., an electric shaving machine) from an image comprising multiple objects. In other examples, the monitoring component 110 can learn to identify and/or extract one or more discrete words (e.g., “cancer”) from content comprising multiple words (e.g., via natural language processing techniques and/or a convolutional neural network).

According to another embodiment, the monitoring component 110 can implement various feature extraction techniques that employ visual descriptors to classify objects in a digital image (e.g., histogram of oriented gradients (HOG), speeded-up robust features (SURF), local binary patterns (LBP), etc.). In such an example, the process of classifying objects in a digital image constitutes identifying and/or extracting one or more key data entities from a digital image (e.g., an image captured by the monitoring component 110 as described above). In several embodiments, the monitoring component 110 can classify images using image processing techniques such as segmentation, object detection, and/or image classification. For example, object detection can facilitate identifying the distinct entities co-existing in the same image and the image classification can facilitate assigning a category to each entity. In such an example, the set of all the categories with which an image is labelled defines the semantic of the image itself.

The monitoring component 110 can further include and/or be coupled with (e.g., communicatively, electrically, operatively, etc.) various logic aspects (not illustrated in FIG. 1) that can provide for analyzing the extracted data entities and deriving one or more logical inferences about the extracted data entities. Examples of such logic aspects the monitoring component 110 can comprise and/or be coupled with can include, but are not limited to, one or more semantic reasoners, rules engines, machine learning models, and/or the like. For example, the monitoring component 110 can comprise and/or be coupled with a semantic reasoner that can receive, as inputs, one or more data entities extracted by the monitoring component 110 and/or one or more domain ontologies. For instance, the one or more domain ontologies can include various inference definitions and/or instructions that dictate how the semantic reasoner analyzes the one or more extracted data entities and derives logical inferences from such analysis. In such an example, the monitoring component 110 (e.g., utilizing a semantic reasoner and domain ontology) can facilitate inferring “masculine” as a logical inference derived from a digital image of an electric shaving machine extracted from content captured by the monitoring component 110. According to several embodiments, to facilitate inferring the logical inference, the monitoring component 110 can employ a semantic reasoner over the semantic concepts extracted from the images. For example, a digital image of an electric shaving machine can be associated with, but not limited to, the semantic concepts of “masculine,” “electric device,” “shaving,” and/or “hygiene product”. In such an example, the monitoring component 110 can highlight the term “masculine” as potentially sensitive information. This can be further enforced if, for example, the monitoring component 110 identifies in the textual component associated with the image similar entities, such as further descriptions of the electric shaving machine and/or references to the term “masculine.”

According to numerous embodiments, to facilitate determining whether the content communicated by the content sources 124 violates one or more of the rules 108, the monitoring component 110 can further comprise and/or be coupled with (e.g., communicatively, electrically, operatively, etc.) various evaluating aspects (not illustrated in FIG. 1) that can provide for matching the one or more extracted data entities and/or the one or more derived logical inferences to the data 106 and/or the rules 108. Examples of such evaluating aspects the monitoring component 110 can comprise and/or be coupled with can include, but are not limited to, an associative array, hash table/hash function, database index, database table, machine learning models, and/or the like. For example, the monitoring component 110 can employ a hash table/hash function, which implements an associative array structure to facilitate matching keys to values. According to one illustration, the keys can be the one or more extracted data entities and/or the one or more derived logical inferences, and the values can be the data 106 and/or the rules 108. In another illustration, the keys can be the data 106 and/or the rules 108, and the values can be the one or more extracted data entities and/or the one or more derived logical inferences.

According to several embodiments, the monitoring component 110 can match the rules 108 against the semantic concepts extracted by the monitoring component 110. In an embodiment, the rules 108 can be of the form [semantic concept 1, semantic concept 2, . . . , semantic concept n]->[allow/deny]. In such an example, the monitoring component 110 can group all the semantic concepts extracted from the content received from the content sources 124 and send such concepts to the database component 104 and/or the data 106. In this example, all the rules 108 associated with the data 106 data items matching the semantic concepts (e.g., [semantic concept 1, semantic concept 2, . . . , semantic concept n]) are activated, thereby activating the corresponding rule behavior (e.g., [allow/deny]).

Continuing with the digital image of an electric shaving machine extracted from content captured by the monitoring component 110 as described above, in one embodiment, the monitoring component 110 can employ a hash table/hash function and associative array structure to facilitate matching the derived logical inference “masculine” to the data 106 and/or the rules 108. In such an example, if the data 106 includes a data item defined as “masculine” and the rules 108 associated with the “masculine” data item designate such a data item as “sensitive” and “cannot be used” by “all” content entities, then the monitoring component 110 can affirmatively determine that the content communicated by the content sources 124 violates the rules 108. In an embodiment, the monitoring component 110 can use a hash function to process the semantic concepts to hashed values. In such an embodiment, the data 106 that are stored in the database component 104 can also be processed by the same hash function utilized by the monitoring component 110 (same function definition and compatible initialization parameters). In such an example, to perform the match to determine if a given rule applies to the content analyzed, the monitoring component 110 can perform a lookup (e.g., utilizing the hash function) into the database component 104. In this example, to facilitate the lookup, the monitoring component 110 can perform equality check between the hashed semantic concepts and the hashed values of the data 106 and/or the rules 108. According to several embodiments, the monitoring component 110 can comprise and/or employ any sufficiently robust hash function including, but not limited to, a Secure Hash Algorithm 1 (SHA-1), Secure Hash Algorithm 256 (SHA-256), SWIFFT, and/or the like.

According to numerous illustrations, the monitoring component 110 can provide for analyzing (e.g., as previously described) the content communicated by the content sources 124 based on one or more specifications 128. Examples of the one or more specifications 128 can include, but are not limited to, various hardware and/or software associated with one or more semantic reasoners, domain ontologies, rules engines, machine learning models, and/or the like. In some embodiments, the specifications 128 can be stored in and/or operatively coupled with the specification component 126. In other implementations, the specifications 128 and/or the specification component 126 can be included in the client device 102 and/or the monitoring component 110. In other examples, the specifications 128 and/or the specification component 126 can be stored in the memory 118. According to other examples, the specifications 128 and/or the specification component 126 can be stored at various external and/or remote locations that can be accessible to the client device 102 and/or the monitoring component 110 via a direct connection or via the networks 122.

The specifications 128 and/or the specification component 126 can facilitate customizing (e.g., based on unique settings, instructions, procedures, etc.) the various functions of the monitoring component 110 (e.g., capturing the content, extracting the data entities, deriving logical inferences based on the data entities, and/or matching the logical inferences to the data 106 and/or the rules 108). For example, the specifications 128 and/or the specification component 126 can be related to and/or defined (e.g., generated, populated, modified, manipulated, etc.) by an entity (e.g., a client entity). To facilitate defining the specifications 128 and/or the specification component 126 according to several illustrations, the client device 102, the monitoring component 110, and/or the specification component 126 can include and/or be coupled with (e.g., communicatively, electrically, operatively, etc.) various computer input/output devices (e.g., a mouse, a keyboard, a display monitor, etc.), an operating system, and/or other hardware and/or software suitable to facilitate generating, populating, modifying, and/or manipulating the specifications 128. Examples of such other hardware and/or software can include, but are not limited to, a graphics processing unit, a web browser application, a spreadsheet application, digital feature capturing software, ontology editor software (e.g., “Anzo for Excel,” “Protégé,” “NeOn Toolkit,” “Neologism,” etc.), and/or machine learning software (e.g., MATLAB® and/or other suitable software that can provide for analyzing data, developing algorithms, and/or generating mathematical models).

In one example, a client entity can define the specifications 128 and/or the specification component 126 by provisioning the client device 102 and the various hardware and/or software components described above to generate, populate, modify, and/or manipulate a unique domain ontology (e.g., via an ontology editor application utilizing Web Ontology Language (OWL), Resource Description Framework (RDF), etc.). For instance, the unique domain ontology can include inference definitions and/or instructions defined by a client entity (e.g., via an ontology editor application) that direct a semantic reasoner and/or the monitoring component 110 to infer “masculine,” “female,” “cat,” and/or “dog” as logical inferences derived from a digital image of an electric shaving machine extracted from content captured by the monitoring component 110.

In another illustration, an entity (e.g., a client entity) can define the specifications 128 and/or the specification component 126 by provisioning the client device 102 and the various hardware and/or software components described above to generate, populate, modify, and/or manipulate a machine learning model (e.g., a recurrent neural network). For example, a client entity can generate and/or implement the machine learning model (e.g., via MATLAB®) according to unique data inputs, instructions, and/or algorithms defined by the client entity. In such an example, by utilizing a machine learning model, such as a recurrent neural network, the monitoring component 110 can be trained to identify and/or extract one or more data entities (e.g., based on the unique data inputs, instructions, and/or algorithms defined by the entity) from the content captured by the monitoring component 110. For instance, the monitoring component 110 can be trained to identify and/or extract discrete objects embedded in images and classify such objects in categories that do not accurately represent the objects (e.g., identifying an “electric shaving machine” object in an image and classifying the object in a “masculine,” “female,” “cat,” and/or “dog” category).

It should be appreciated that analyzing the content communicated by the content sources 124 as previously described, based on the one or more specifications 128 defined by a client entity (e.g., the unique domain ontologies and/or machine learning models described above) reduces the number of processing errors associated with incorrectly detecting unauthorized use of sensitive information. Consequently, the accuracy, efficiency, and/or performance of a processor (e.g., the processor 116) is improved.

In several embodiments, the notification component 112 can facilitate generating information indicative of one or more violations of the rules 108 based on a determination by the monitoring component 110 that the content communicated by the content sources 124 violates one or more of the rules 108. To facilitate generating information indicative of one or more violations of the rules 108 according to multiple illustrations, the client device 102 and/or the notification component 112 can comprise and/or be coupled with (e.g., communicatively, electrically, operatively, etc.) various notification aspects (not illustrated in FIG. 1) that can provide for automatically notifying an entity/entity device to inform such entity/client device 102 of the one or more violations. For example, the client device 102 and/or the notification component 112 can include and/or be coupled with various hardware and/or software components that can provide for automatically notifying an entity/client device 102 to inform such entity/client device 102 of the one or more violations of the rules 108. For instance, the client device 102 and/or the notification component 112 can include and/or be coupled with various computer input/output devices (e.g., a mouse, a keyboard, a display monitor, speakers, etc.), an operating system, and/or one or more software applications suitable for generating and/or communicating such notification to an entity (e.g., electronic mail (e-mail) application, text messaging application, push notification application etc.).

According to one example, based on a determination by the monitoring component 110 that the content communicated by the content sources 124 violates one or more of the rules 108 (e.g., as described above), the notification component 112 can automatically generate information indicative of the one or more violations of the rules 108 (e.g., via transmitting an e-mail message, text message, a push notification, initiating a call, turning on a light or activating a sensor, causing a letter to be printed or causing any other physical world change or electronic output to occur, to the computing devices 120 (or any other devices) via the networks 122). In another example, the notification component 112 can facilitate automatically notifying an entity/client device related to and/or associated with the data 106 and/or the rules 108 to inform such entity of the one or more violations (e.g., via transmitting an e-mail message, a text message, a push notification, and/or the like, to the client device 102). According to another illustration, the notification component 112 can facilitate automatically notifying an entity/client device 102 responsible for generating or communicating the content to inform such entity of the one or more violations (e.g., via transmitting an e-mail message, text message, a push notification, initiating a call, turning on a light or activating a sensor, causing a letter to be printed or causing any other physical world change or electronic output to occur, to the computing devices 120 (or any other devices) via the networks 122). In still another example, the notification component 112 can facilitate automatically notifying a third-party entity that is not associated with the data 106, the rules 108, or the content to inform such third-party entity of the one or more violations (e.g., via transmitting an e-mail message, text message, a push notification, initiating a call, turning on a light or activating a sensor, causing a letter to be printed or causing any other physical world change or electronic output to occur, to the computing devices 120 (or any other devices) via the networks 122).

The various components of the system 100 (e.g., the client device 102, the monitoring component 110, the one or more computing devices 120, the content sources 124, the specification component 126, etc.) can be connected either directly (e.g., via a data cable, such as High-Definition Multimedia Interface (HDMI), recommended standard (RS) 232, Ethernet cable, etc.) or via the networks 122. The networks 122 can include wired and wireless networks, including, but not limited to, a cellular network, a wide area network (WAN) (e.g., the Internet) or a local area network (LAN). For example, the client device 102 can communicate with the one or more computing devices 120 and/or the content sources 124 (and vice versa) using virtually any desired wired or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In such an example, the client device 102 can thus include hardware (e.g., a central processing unit (CPU), a transceiver, a decoder), software (e.g., a set of threads, a set of processes, software in execution) or a combination of hardware and software that facilitates communicating information between the client device 102 and external systems, sources, and devices.

In numerous embodiments, the client device 102 and/or the computing devices 120 can be any type of component, machine, device, facility, apparatus, and/or instrument that comprises a processor and/or can be capable of effective and/or operative communication with a wired and/or wireless network. All such embodiments are envisioned. For example, the client device 102 and/or the computing devices 120 can be a server device, a computing device, and the like. In various embodiments, any number of different types of devices can be associated with or include the components shown in FIG. 1 (e.g., the database component 104, the monitoring component 110, the notification component 112, the device bus 114, the processor 116, the memory 118, etc.). Components, machines, apparatuses, devices, facilities, and/or instrumentalities that can comprise the client device 102 and/or the computing devices 120 can include tablet computing devices, handheld devices, server class computing machines and/or databases, laptop computers, notebook computers, desktop computers, cell phones, smart phones, consumer appliances and/or instrumentation, industrial and/or commercial devices, digital assistants, multimedia Internet enabled phones, multimedia players, and the like.

In various embodiments, the client device 102 and associated components (e.g., the database component 104, the monitoring component 110, the notification component 112, etc.) can be a content analyzing computing system associated with technologies, such as, but not limited to, computing technologies, network technologies, communication technologies, database technologies, data processing technologies (e.g., related to data capturing, extracting, mapping, matching, inferring, mining, etc.), data management technologies (e.g., related to data acquisition, disposition, possession, use, inference, etc.), artificial intelligence technologies, and/or other digital technologies. The client device 102 and associated components can be employed to solve problems that are highly technical in nature (e.g., automated monitoring, classification and processing of data, automated inferencing of data, semantic and ontological processing, which can be related to automated detection of unauthorized use of sensitive information in content communicated over a network), that are not abstract and that cannot be performed as a set of mental acts by a human. For example, a human could not automatically (e.g., within a matter of seconds or less) analyze the voluminous amount of content frequently received over the Internet to accurately, effectively, efficiently, and consistently detect sensitive information used in the content, then determine whether the use is authorized or unauthorized, and generate a notification for unauthorized uses. Further, in certain embodiments, some of the processes (e.g., semantic processing, generation of inferences based on data, classification of large amounts of data, etc.) performed can be performed by one or more specialized computers (e.g., one or more specialized processing units, a specialized computer with a content analyzing computing component, a specialized database component, a specialized monitoring component, a specialized notification component, and so on) to carry out defined tasks related to detecting unauthorized use of sensitive information in content communicated over a network as discussed herein.

Numerous examples of the client device 102 and associated components (e.g., the database component 104, the monitoring component 110, the notification component 112, etc.) can be employed to solve new problems that arise through advancements in technologies mentioned above (e.g., computing technologies, network technologies, communication technologies, database technologies, data processing technologies, data management technologies, artificial intelligence technologies, and/or other digital technologies). For example, as such technologies evolve, so too will technologies designed to compromise and/or exploit an entity's sensitive information. For instance, as computing, communication, and/or network technologies evolve, the client device 102 and associated components can be employed by an entity (e.g., a client entity) without involvement from another entity (e.g., a server entity) as disclosed herein and/or provisioned for implementation by new computing devices not yet known and/or developed (e.g., neural implant computing devices). In such an example, the client device 102 and associated components can be utilized to detect unauthorized use of sensitive information in new forms of content and/or media not yet known and/or developed (e.g., hologram media). Continuing with this example, the client device 102 and associated components can be employed to detect unauthorized use of sensitive information in content communicated over a new type of network environment not yet known and/or developed (e.g., a telepathic network).

It should be appreciated that the client device 102 and associated components (e.g., the database component 104, the monitoring component 110, the notification component 112, etc.) can facilitate analyzing content communicated over a network to detect unauthorized use of a finite set of defined data based on a finite set of defined rules governing use of the data (e.g., as opposed to analyzing the content to detect unauthorized use of a potentially infinite set of data associated with an entity, without utilizing defined rules governing the use of such data by another entity). By facilitating such analysis according to a finite set of defined data (e.g., the data 106) based on a finite set of defined rules governing use of the data (e.g., the rules 108), the processing time associated with detecting unauthorized use of sensitive information is reduced, thereby improving the efficiency and/or performance of a processor (e.g., the processor 116). Further, by facilitating such analysis according to a finite set of defined data (e.g., the data 106) based on a finite set of defined rules governing use of the data (e.g., the rules 108), the number of processing errors associated with incorrectly detecting unauthorized use of sensitive information is reduced, thereby improving the accuracy of a processor (e.g., the processor 116). Consequently, it should be appreciated that the client device 102 and associated components can provide technical improvements (e.g., the improved processing efficiency, processing performance, and/or processing accuracy described above) to systems including, but not limited to computing systems, data processing and/or management systems, data protection systems, content analyzing systems, identity protection systems, advertising systems, security systems, and/or other systems.

It should be further appreciated that the client device 102 and associated components (e.g., the database component 104, the monitoring component 110, the notification component 112, etc.) can automatically analyze content communicated by the content sources 124 in a manner that cannot be performed by a human (e.g., using techniques, technologies, and/or algorithms that are greater than the capability of a single human mind). For example, the quantity of data processed, the speed at which the data is processed, and/or the variety of different types of data processed by the client device 102 and associated components over a defined period of time can be respectively greater, faster, and differ more than the amount, speed, and variety that can be processed by a single human mind over the same period of time. Further, as metadata can be embedded within the content, and thus cannot be discerned with the human eye or evaluated in the human mind, it should be appreciated that the client device 102 and associated components can facilitate automatically analyzing such metadata in accordance with several embodiments described herein.

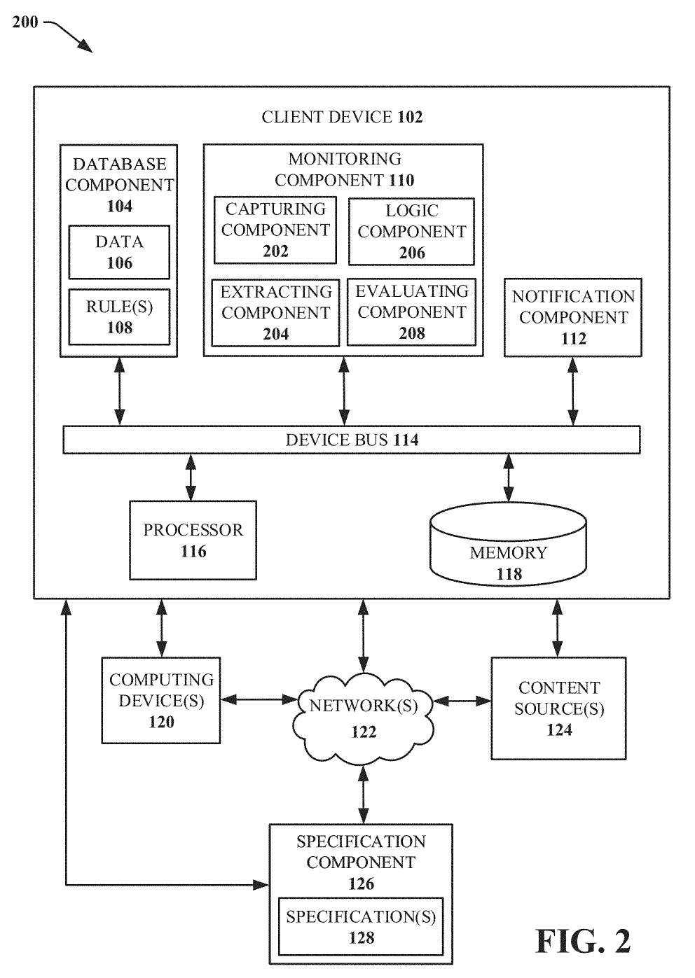

FIG. 2 illustrates a block diagram of another example, non-limiting system 200 that facilitates detecting unauthorized use of sensitive information in content communicated over a network in accordance with one or more embodiments of the disclosed subject matter. The system 200 presents some example components of the monitoring component 110 that can perform operations associated with analyzing content communicated over a network by the content sources 124 to determine whether the content violates one or more of the rules 108. In one or more embodiments, the system 200 is a subsystem of the system 100 (e.g., the system 100 can include the system 200, and vice versa). Repetitive description of like elements employed in respective embodiments is omitted for sake of brevity.

As illustrated in FIG. 2, the monitoring component 110 can comprise capturing component 202, extracting component 204, logic component 206, and/or evaluating component 208. Although the monitoring component 110 can comprise the various components depicted in FIG. 2 as described above (e.g., the capturing component 202, the extracting component 204, the logic component 206, and/or the evaluating component 208), it should be appreciated that the embodiment shown in FIG. 2 is for illustration only, and as such, the architecture of the monitoring component 110 is not so limited.

In several embodiments, the capturing component 202 can facilitate capturing content communicated by the content sources 124 in the same or similar manner, utilizing the same or similar components as described above with reference to FIG. 1 and the content capturing aspects associated with the monitoring component 110. For example, the capturing component 202 can comprise and/or be coupled with (e.g., communicatively, electrically, operatively, etc.) various content capturing components (e.g., webpage capturing software, such as “FireShot Pro,” “IceCream Screen Recorder,” PAGE VAULT BROWSER®, etc.). According to one example, an entity (e.g., a client entity) can utilize the client device 102 and/or various associated hardware and/or software components (e.g., a mouse, a keyboard, a display monitor, an operating system, etc.) to implement the monitoring component 110 and/or the capturing component 202. In such an example, the monitoring component 110 and/or the capturing component 202 can deploy (e.g., via a web browser application) the content capturing hardware and/or software components described above (e.g., webpage capturing software) to facilitate capturing any and/or all of the various types of data rendered on and/or associated with a website (e.g., the website URL (Uniform Resource Locator), metadata, source code, hyperlinks, images, video, text, audio, animation, graphical user interface (GUI), form-based interface, natural language interface, etc.).

According to numerous examples, the extracting component 204 can facilitate extracting one or more data entities from the content captured by the capturing component 202 in the same or similar manner, utilizing the same or similar components as described above with reference to FIG. 1 and the data extracting aspects associated with the monitoring component 110. For example, the extracting component 204 can comprise and/or be coupled with (e.g., communicatively, electrically, operatively, etc.) various data extracting components (e.g., hardware, software, and/or algorithms related to natural language processing, named-entity recognition, image processing, object recognition, audio recognition, speech recognition, machine learning models, etc.). In one example, an entity (e.g., a client entity) can utilize the client device 102 and/or various associated hardware and/or software components (e.g., a mouse, a keyboard, a display monitor, an operating system, etc.) to implement the extracting component 204. In such an illustration, the extracting component 204 can facilitate developing and/or deploying (e.g., via machine learning software, such as MATLAB®) a deep learning model (e.g., a convolutional neural network). In this example, by utilizing a deep learning model, the extracting component 204 can learn to identify and/or extract one or more distinct data entities (e.g., discrete objects in an image, discrete words, discrete metadata, etc.) from the content captured by the capturing component 202. According to another example, the extracting component 204 can implement various feature extraction techniques that employ visual descriptors to classify objects in a digital image (e.g., histogram of oriented gradients (HOG), speeded-up robust features (SURF), local binary patterns (LBP), etc.).

In multiple examples, the logic component 206 can provide for analyzing the extracted data entities and deriving one or more logical inferences about the extracted data entities in the same or similar manner, utilizing the same or similar components as described above with reference to FIG. 1 and the logic aspects associated with the monitoring component 110. For example, the logic component 206 can comprise and/or be coupled with (e.g., communicatively, electrically, operatively, etc.) one or more semantic reasoners, rules engines, machine learning models, and/or the like, that can provide for mapping one or more data entities extracted from the content to one or more semantic entities. In one example, an entity (e.g., a client entity) can utilize the client device 102 and/or various associated hardware and/or software components (e.g., a mouse, a keyboard, a display monitor, an operating system, etc.) to implement the logic component 206. In such an illustration, the logic component 206 can employ a semantic reasoner that can receive, as inputs, one or more data entities extracted by the extracting component 204 and/or one or more domain ontologies. For instance, the one or more domain ontologies can include various inference definitions and/or instructions that dictate how the semantic reasoner analyzes the one or more extracted data entities and derives logical inferences from such analysis (e.g., via mapping one or more extracted data entities to one or more semantic entities).

In other examples, the logic component 206 can facilitate analyzing extracted data entities and deriving one or more logical inferences about the extracted data entities based on the one or more specifications 128 in the same or similar manner, utilizing the same or similar components as described above with reference to FIG. 1, the monitoring component 110, and the specification component 126. For example, the logic component 206 can facilitate analyzing extracted data entities and deriving one or more logical inferences about the extracted data entities based on one or more unique domain ontologies (e.g., defined by a client entity using an ontology editor application utilizing Web Ontology Language (OWL), Resource Description Framework (RDF), etc.). In another illustration, the logic component 206 can facilitate analyzing extracted data entities and deriving one or more logical inferences about the extracted data entities based on one or more machine learning models that can be generated and/or executed based on unique data inputs, instructions, and/or algorithms defined by the entity.

According to several implementations, the evaluating component 208 can provide for matching one or more extracted data entities and/or one or more semantic entities to the data 106 and/or rules 108 to facilitate determining whether the content communicated by the content sources 124 violates one or more of the rules 108. The evaluating component 208 can comprise and/or be coupled with (e.g., communicatively, electrically, operatively, etc.) one or more evaluating aspects (e.g., associative array, hash table/hash function, database index, database table, machine learning models, etc.) that can allow for matching the one or more extracted data entities and/or the one or more semantic entities to the data 106 and/the rules 108. In one example, an entity (e.g., a client entity) can utilize the client device 102 and/or various associated hardware and/or software components (e.g., a mouse, a keyboard, a display monitor, an operating system, etc.) to implement the evaluating component 208. In such an illustration, the evaluating component 208 can employ a hash table/hash function, which implements an associative array structure to facilitate matching keys to values. According to one example, the keys can be the one or more extracted data entities and/or the one or more semantic entities, and the values can be the data 106 and/or the rules 108. According to another, the keys can be the data 106 and/or the rules 108, and the values can be the one or more extracted data entities and/or the one or more semantic entities.

By way of illustration, not limitation, the evaluating component 208 can employ a hash table/hash function and associative array structure to facilitate matching the semantic entity “masculine” to the data 106 and/or the rules 108. In such an example, if the data 106 includes a data item defined as “masculine” and the rules 108 associated with the “masculine” data item designate such a data item as “sensitive” and “cannot be used” by “all” content entities, then the monitoring component 110 can affirmatively determine that the content communicated by the content sources 124 violates the rules 108.

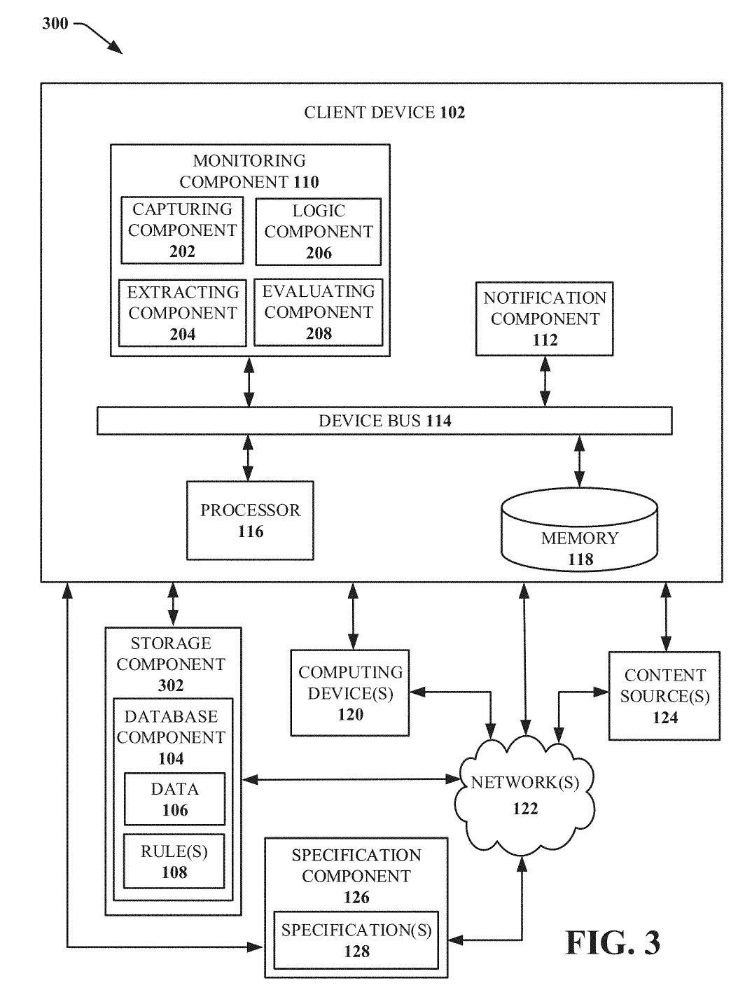

FIG. 3 illustrates a block diagram of another example, non-limiting system 300 that facilitates detecting unauthorized use of sensitive information in content communicated over a network in accordance with one or more embodiments of the disclosed subject matter. The system 300 can comprise one or more of the components and/or functionality of the system 100 and/or the system 200, and vice versa. The system 300 can comprise storage component 302. Repetitive description of like elements employed in respective embodiments is omitted for sake of brevity.

As described above with reference to FIG. 1, the database component 104, the data 106, and/or the rules 108 can be located at one or more suitable external and/or remote storage devices that are accessible to the client device 102 and/or the monitoring component 110 and associated components via a direct connection or via the networks 122. For example, the database component 104, the data 106, and/or the rules 108 can be stored in the storage component 302 depicted in FIG. 3. According to one example, the storage component 302 can be one or more external computer readable storage mediums, remote storage devices, server computer memory, cloud based storage device, and/or the like. In this example, access to the storage component 302, and therefore, access to the database component 104, the data 106, and/or the rules 108 can be protected utilizing various access control features associated with and/or inherent to the storage component 302 and/or the direct connection or network connection implemented (e.g., password protection, encryption/decryption, firewall protection, Network Access Control (NAC), etc.). By implementing such access control features (e.g., via the client device 102, the networks 122, the storage component 302, etc.), the system 300 can facilitate protected and/or exclusive access to the database component 104, the data 106, and/or the rules 108 (e.g., access can be exclusive to the entity related to and/or associated with the data 106 and/or the rules 108, such as a client entity).

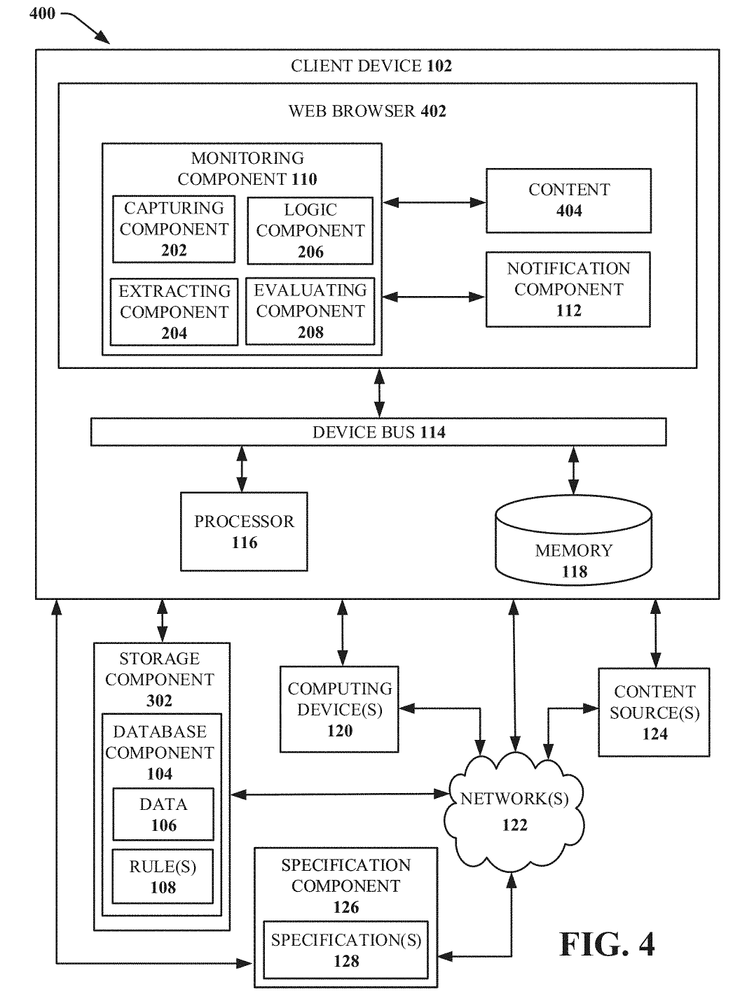

FIG. 4 illustrates a block diagram of another example, non-limiting system 400 that facilitates detecting unauthorized use of sensitive information in content communicated over a network in accordance with one or more embodiments of the disclosed subject matter. The system 400 can comprise one or more of the components and/or functionality of the system 100, the system 200, and/or the system 300, and vice versa. The system 400 can comprise web browser 402 and/or content 404. Repetitive description of like elements employed in other embodiments described herein is omitted for sake of brevity.

According to one illustration depicted in FIG. 4, the client device 102 can comprise and/or be coupled with (e.g., communicatively, electrically, operatively, etc.) the web browser 402. In several examples, the web browser 402 can comprise and/or provide for execution of the monitoring component 110 and/or the notification component 112 as previously described with reference to FIG. 1 and the system 100. Additionally or alternatively, the web browser 402 can comprise and/or provide for execution of the capturing component 202, the extracting component 204, the logic component 206, and/or the evaluating component 208 as previously described with reference to FIG. 2 and the system 200. According to multiple embodiments, the web browser 402 can be any of a variety of web browser applications suitable for implementation by the client device 102, including, but not limited to, FIREFOX®, INTERNET EXPLORER®, SAFARI®, and/or the like.

According to an example, the web browser 402 can further include the content 404. In one illustration, the client device 102 and/or the web browser 402 can receive the content 404 communicated by the content sources 124 via the networks 122. In such an embodiment, the content 404 and/or the notification component 112 can be electrically, communicatively, and/or operatively coupled with the monitoring component 110 within the web browser 402. According to multiple illustrations, the content 404 can include, but is not limited to, advertisements, search engine query results, and/or social network media (e.g., content generated by the social network platform administrator and/or content generated by other social network users, such as postings, image tags, user-to-user messages, etc.). Additionally or alternatively, the content 404 can include, but is not limited to, any of a variety of user interfaces (e.g., graphical user interface (GUI), form-based interface, natural language interface, etc.) that can comprise various types of media (e.g., text, image, audio, video, animation, etc.).

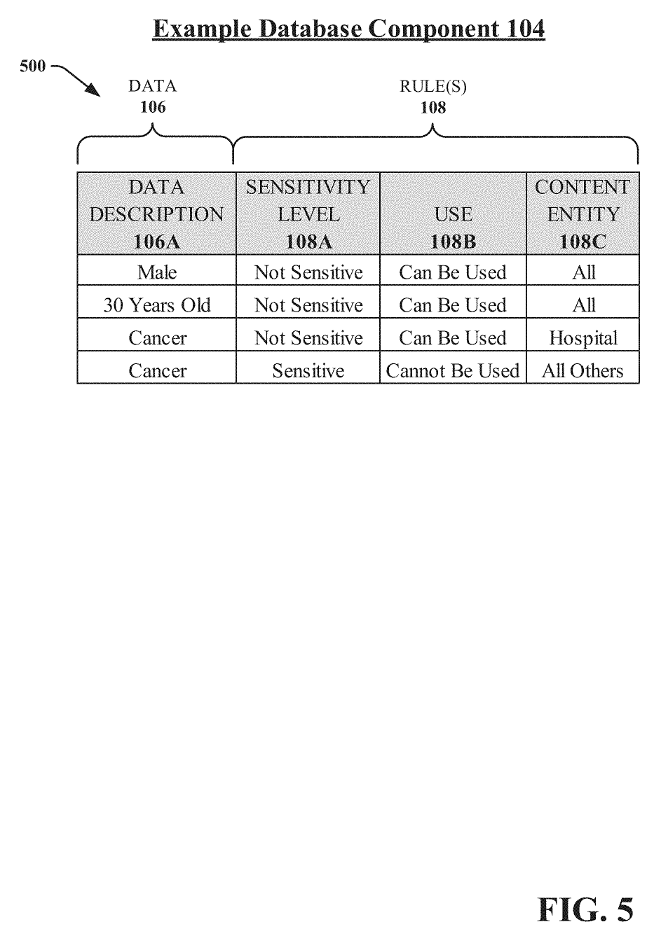

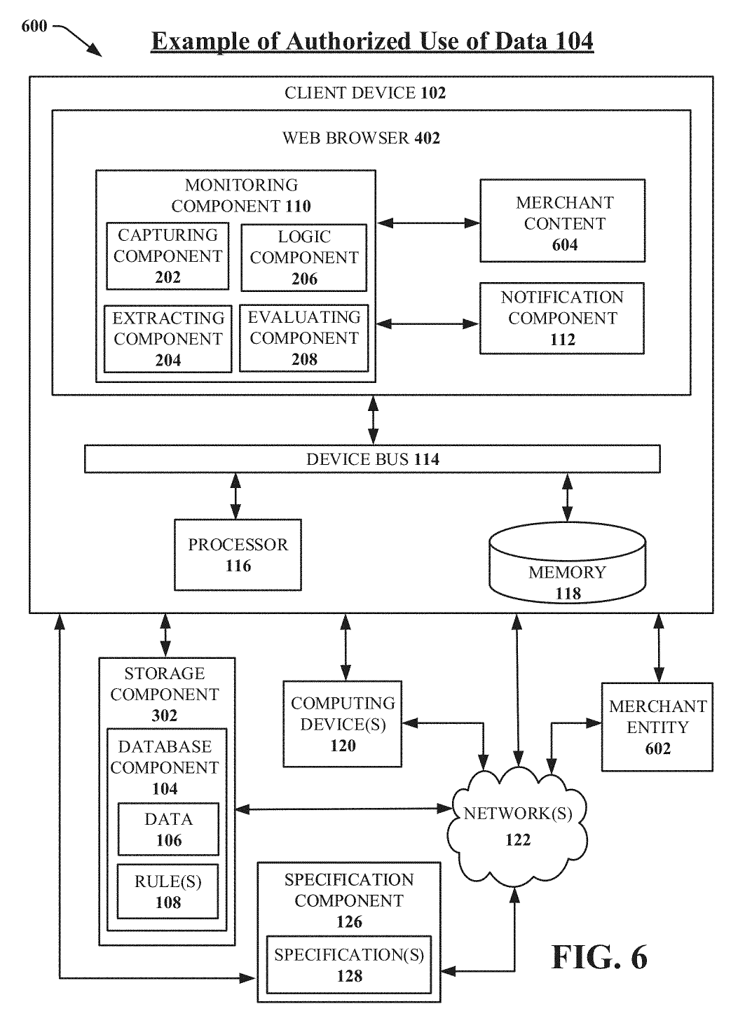

FIG. 5 illustrates non-limiting example information 500 stored in the database component 104 including examples of the data 106 and the rules 108 in accordance with one or more embodiments of the disclosed subject matter. In various embodiments, system 600 depicted in FIG. 6 can include or be included within one or more of the components and/or functionality of the system 100, the system 200, the system 300, the system 400 and vice versa. The information 500 can comprise one or more subsets of the data 106 (e.g., data description 106A, etc.). The information 500 can comprise one or more subsets of the rules 108 (e.g., sensitivity level 108A, use 108B, content entity 108C, etc.). The information 500 can be defined (e.g., generated, populated, modified, manipulated, reviewed, etc.) by an entity (e.g., a client entity) in the same and/or similar manner as the database component 104, the data 106, and/or the rules 108 can be defined (e.g., as described above with reference to FIG. 1). Repetitive description of like elements employed in other embodiments described herein is omitted for sake of brevity.

According to several implementations, the one or more subsets of the rules 108 (e.g., the sensitivity level 108A, the use 108B, the content entity 108C, etc.) can be associated with one another and/or with the one or more subsets of the data 106 (e.g., the data description 106A, etc.). In various examples, the sensitivity level 108A subset can comprise designations including, but not limited to, “not sensitive” and “sensitive.” In other illustrations, the use 108B subset can comprise designations including, but not limited to, “can be used” and “cannot be used.” In numerous other embodiments, the content entity 108C subset can comprise designations including, but not limited to, “all,” “all others,” and/or specifically identified content sources, such as “hospital.” By way of illustration, not limitation, as shown in the information 500 depicted in FIG. 5, the data description 106A subset can include a data item defined as “masculine” which can be associated with the sensitivity level 108A designation “not sensitive.” In another example, the data description 106A subset including a data item defined as “masculine” can be associated with the use 108B designation “can be used.” In yet another embodiment, the data description 106A subset including a data item defined as “masculine” can be associated with the content entity 108C designation “all.” According to the rules 108 subset designations described above, in various illustrations, the data description 106A subset including a data item defined as “masculine” can be designated as “not sensitive” and “can be used” by “all” content sources, under the rules 108.

The one or more subsets of the data 106 (e.g., the data description 106A, etc.) and the one or more subsets of the rules 108 (e.g., the sensitivity level 108A, the use 108B, the content entity 108C, etc.) depicted in FIG. 5 are included for illustration, not limitation. In various examples, the information 500 can comprise any number and/or variety, or combination thereof, of different subsets that can be used as the one or more subsets of the data 106 and/or the one or more subsets of the rules 108. Similarly, the one or more designations (e.g., “not sensitive,” “sensitive,” “can be used,” “cannot be used,” “all,” “all others,” etc.) associated with the one or more subsets of the rules 108 (e.g., the sensitivity level 108A, the use 108B, the content entity 108C, etc.) depicted in FIG. 5 are included for illustration, not limitation. In numerous examples, the information 500 can comprise any number and/or variety, or combination thereof, of different designations that can be associated with the one or more subsets of the rules 108.

FIG. 6 illustrates an example of a block diagram employed to describe an example of authorized use of data in accordance with one or more embodiments of the disclosed subject matter. In various embodiments, system 600 depicted in FIG. 6 can include or be included within one or more of the components and/or functionality of the system 100, the system 200, the system 300, the system 400 and vice versa. As shown, system 600 can comprise merchant entity 602 and/or merchant content 604. Repetitive description of like elements employed in other embodiments described herein is omitted for sake of brevity.

As illustrated in the example depicted in FIG. 6, the merchant entity 602 can communicate (e.g., via the networks 122) the merchant content 604, which can be received by and/or rendered in the web browser 402 (e.g., via the client device 102). In one implementation, the merchant content 604 can be an online advertisement including an image of an electric shaving machine, along with the text: “Buy this new shaving machine from Merchant Entity.” In other embodiments, any particular content can be employed in the embodiments herein.

According to the example illustrated in FIG. 6, the capturing component 202 can capture the merchant content 604 rendered in the web browser 402 (e.g., as described above with reference to FIG. 2 and the capturing component 202). In another example, the extracting component 204 can extract (e.g., as described above with reference to FIG. 2 and the extracting component 204) from the merchant content 604 the image of the electric shaving machine, the words “Merchant Entity,” and/or metadata identifying the merchant entity 602 as the source of the merchant content 604. According to another illustration, the logic component 206 can map (e.g., as described above with reference to FIG. 2 and the logic component 206) the extracted data entity (e.g., the image of an electric shaving machine) to one or more semantic entities to derive the logical consequence that the image of an electric shaving machine infers “masculine.” In another embodiment, the evaluating component 208 can match (e.g., as described above with reference to FIG. 2 and the evaluating component 208) the semantic entity (e.g., “masculine”) and/or the extracted entity (e.g., “Merchant Entity”) to the data 106 and/or the rules 108 to facilitate determining whether the merchant content 604 violates one or more of the rules 108.

According to one example, the evaluating component 208 can match the semantic entity “masculine” to the data item defined as “masculine” included in the data description 106A subset shown in information 500 depicted in FIG. 5. As illustrated in information 500, the data item defined as “masculine” included in the data description 106A can be associated with the rules 108 subset designations including “not sensitive” and “can be used” by “all” content entities, as indicated in the respective subsets of the rules 108 shown in information 500 (e.g., the sensitivity level 108A, the use 108B, and the content entity 108C). In such an example, the monitoring component 110 can determine that the image of the electric shaving machine and the text: “Buy this new shaving machine from Merchant Entity” included in the merchant content 604 communicated by the merchant entity 602 was not a violation of the rules 108 defining use of the “masculine” item in the data 106.

As described above, although various embodiments of the subject disclosure are described in association with online advertisements rendered in a web browser, it should be appreciated that the subject disclosure is not so limited. For example, according to several embodiments discussed herein, the subject disclosure can analyze content associated with and/or rendered in an electronic mail (e-mail) retrieved by a recipient entity device (e.g., the client device 102). In another implementation, the subject disclosure can analyze content associated with an entity that is rendered in an online social network platform and/or environment that can be accessed by the entity device (e.g., the client device 102).

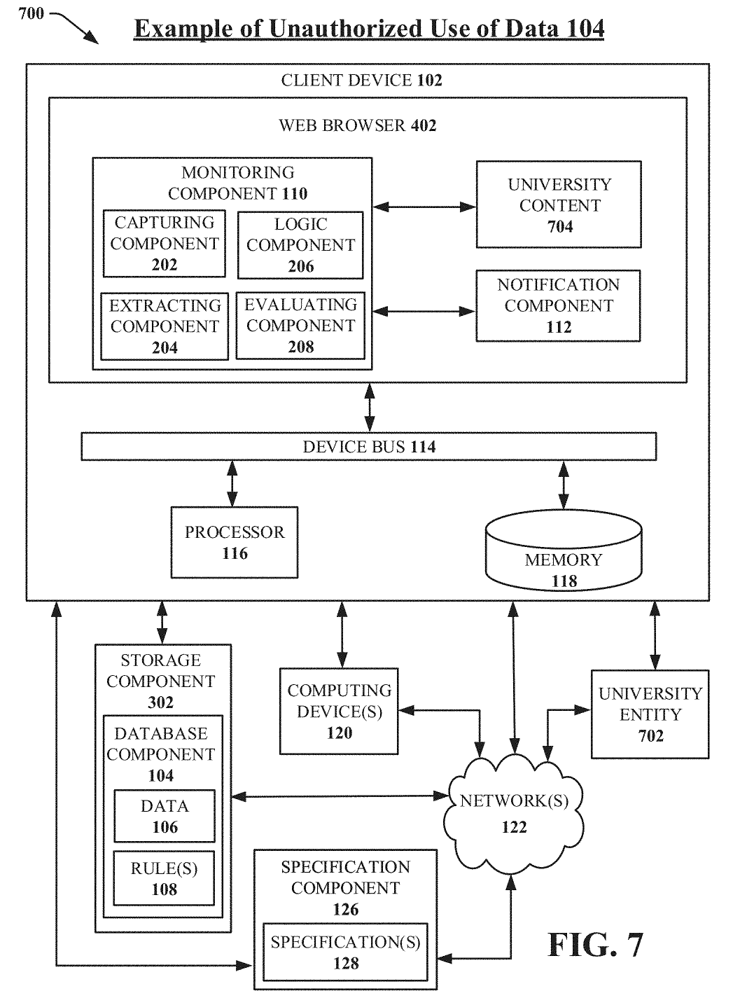

FIG. 7 illustrates an example of a block diagram employed to describe an example of unauthorized use of data in accordance with one or more embodiments of the disclosed subject matter. System 700 depicted in FIG. 7 can include or be included within one or more of the components and/or functionality of the system 100, the system 200, the system 300, the system 400, the system 600, and/or vice versa. As shown, the system 700 can comprise university entity 702 and/or university content 704. Repetitive description of like elements employed in other embodiments described herein is omitted for sake of brevity.

As illustrated in the example depicted in FIG. 7, the university entity 702 can communicate (e.g., via the networks 122) the university content 704, which can be received by and/or rendered in the web browser 402 (e.g., via the client device 102). In one implementation, the university content 704 can be an online advertisement including the text: “Attend the new course on cancer immunotherapy at a special price.”

According to the example illustrated in FIG. 7, the capturing component 202 can capture the university content 704 rendered in the web browser 402 (e.g., as described above with reference to FIG. 2 and the capturing component 202). In another example, the extracting component 204 can extract (e.g., as described above with reference to FIG. 2 and the extracting component 204) from the university content 704 the word “cancer,” the word “course,” and/or metadata identifying the university entity 702 as the source of the university content 704. According to another illustration, the logic component 206 can map (e.g., as described above with reference to FIG. 2 and the logic component 206) the extracted data entity (e.g., the word “cancer,” the word “course,” and/or the metadata identifying the university entity 702 as the source of the content) to one or more semantic entities to derive the logical inferences “cancer,” “course,” and/or “university.” In another embodiment, the evaluating component 208 can match (e.g., as described above with reference to FIG. 2 and the evaluating component 208) the semantic entities (e.g., “cancer,” “course,” and/or “university”) to the data 106 and/or the rules 108 to facilitate determining whether the university content 704 violates one or more of the rules 108.

According to one example, the evaluating component 208 can match the semantic entity “cancer” to the data item defined as “cancer” included in the data description 106A subset shown in information 500 depicted in FIG. 5. As illustrated in information 500, the data item defined as “cancer” included in the data description 106A can be associated with the rules 108 subset designations including “not sensitive” and “can be used” by “hospital” content entities, as indicated in the respective subsets of the rules 108 shown in information 500 (e.g., the sensitivity level 108A, the use 108B, and the content entity 108C).

Further, the data item defined as “cancer” included in the data description 106A subset shown in information 500 can also be associated with the rules 108 subset designations including “sensitive” and “cannot be used” by “all others” content entities, as indicated in the respective subsets of the rules 108 shown in information 500 (e.g., the sensitivity level 108A, the use 108B, and the content entity 108C). In such an example, the evaluating component 208 can match the semantic entity “university” to the data item defined as “all others” included in the content entity 108C subset shown in information 500. Consequently, in this example, as the university entity 702 is not a “hospital,” the monitoring component 110 can determine that the text “cancer” included in the university content 704 violates the rules 108 defining use of the data item defined as “cancer” in the data 106. In this example, the notification component 112 can generate (e.g., as described above with reference to FIG. 1 and the notification component 112) information indicative of the violation of the rules 108 based on the determination by the monitoring component 110 that the university content 704 communicated by the university entity 702 violates the rules 108.

As previously discussed, although various embodiments of the subject disclosure are described in association with online advertisements rendered in a web browser, it should be appreciated that the subject disclosure is not so limited. For example, according to several embodiments discussed herein, the subject disclosure can analyze content associated with and/or rendered in an electronic mail (e-mail) retrieved by a recipient entity device (e.g., the client device 102). In another implementation, the subject disclosure can analyze content associated with an entity that is rendered in an online social network platform and/or environment that can be accessed by the entity device (e.g., the client device 102).

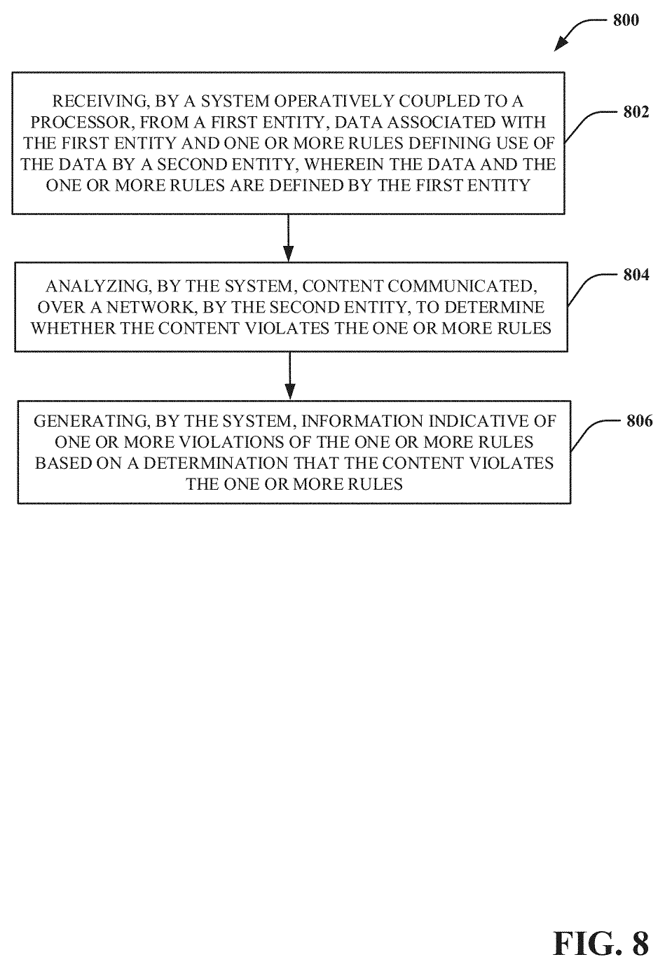

FIG. 8 illustrates a flow diagram of an example, non-limiting computer-implemented process 800 that detects unauthorized use of sensitive information in content communicated over a network in accordance with one or more embodiments of the disclosed subject matter. Repetitive description of like elements employed in other embodiments described herein is omitted for sake of brevity.

At 802, a system operatively coupled to a processor, can receive from a first entity, data associated with the first entity and one or more rules defining use of the data by a second entity (e.g., via the database component 104). The data (e.g., the data 106) and the one or more rules (e.g., the rules 108) can be defined by the first entity. In an example, the system can store the data and the one or more rules such that access to the data and the one or more rules is exclusive to the first entity (e.g., via the client device 102, the memory 118, and/or the storage component 302).

At 804, the system can analyze content communicated over a network by the second entity to determine whether the content violates the one or more rules (e.g., via the monitoring component 110). According to some implementations, analyzing the content can comprise analyzing the content, by the system, based on one or more specifications (e.g., the specifications 128) defined by the first entity.

At 806, the system can generate information indicative of one or more violations of the one or more rules based on a determination that the content violates the one or more rules (e.g., via the notification component 112). In several examples, the system can provide for notifying an entity to inform such entity of the one or more violations (e.g., via the notification component 112).

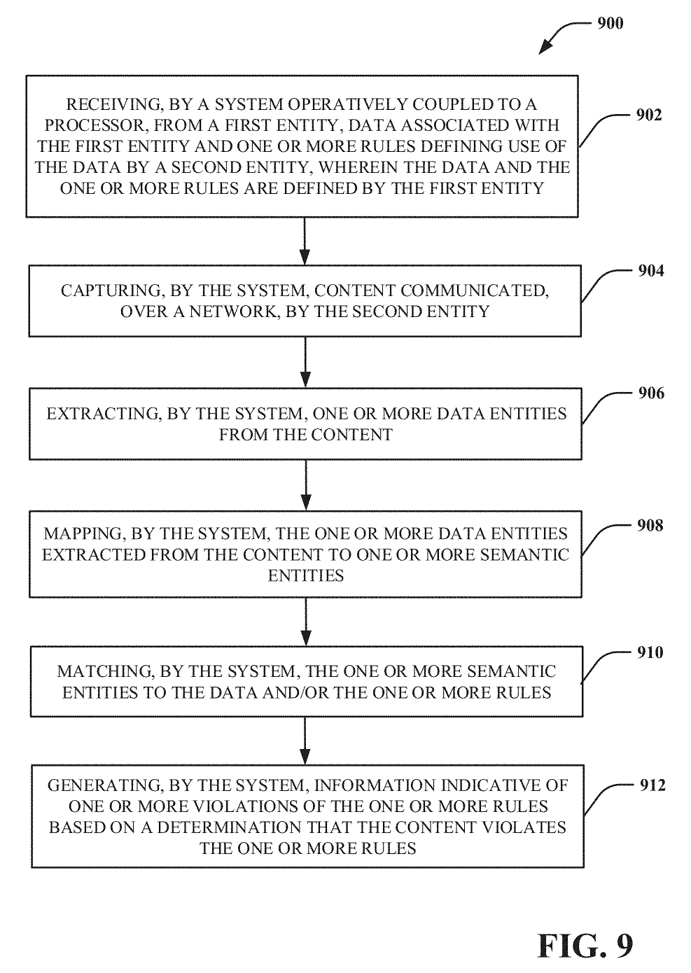

FIG. 9 illustrates a flow diagram of another example, non-limiting computer-implemented process 900 that detects unauthorized use of sensitive information in content communicated over a network in accordance with one or more embodiments of the disclosed subject matter. Repetitive description of like elements employed in other embodiments described herein is omitted for sake of brevity.

At 902, a system operatively coupled to a processor, can receive from a first entity, data associated with the first entity and one or more rules defining use of the data by a second entity (e.g., via the database component 104). The data (e.g., the data 106) and the one or more rules (e.g., the rules 108) can be defined by the first entity. In an example, the system can store the data and the one or more rules such that access to the data and the one or more rules is exclusive to the first entity (e.g., via the client device 102, the memory 118, and/or the storage component 302).

At 904, the system can capture content communicated over a network by the second entity (e.g., via the capturing component 202). At 906, the system can extract one or more data entities from the content (e.g., via the extracting component 204). At 908, the system can map the one or more data entities extracted from the content to one or more semantic entities (e.g., via the logic component 206). According to some implementations, mapping the one or more data entities extracted from the content to one or more semantic entities can comprise mapping, by the system, the one or more data entities extracted from the content to one or more semantic entities based on one or more specifications (e.g., the specifications 128) defined by the first entity. At 910, the system can match the one or more semantic entities to the data and/or the one or more rules (e.g., via the evaluating component 208).

At 912, the system can generate information indicative of one or more violations of the one or more rules based on a determination that the content violates the one or more rules (e.g., via the notification component 112). In several examples, the system can provide for notifying an entity to inform such entity of the one or more violations (e.g., via the notification component 112).

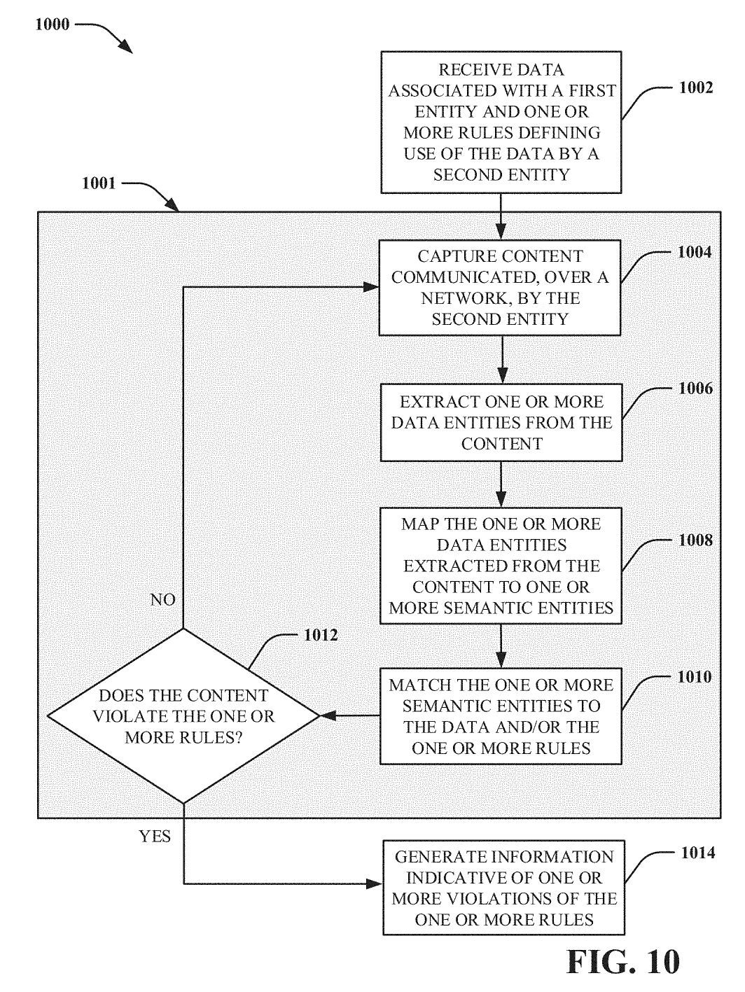

FIG. 10 illustrates a flow diagram of another example, non-limiting computer-implemented process 1000 that detects unauthorized use of sensitive information in content communicated over a network in accordance with one or more embodiments of the disclosed subject matter. In one or more embodiments, the process 1000 can be performed by the client device 102 of the system 400 using various components associated with the system 400 as described below (e.g., the database component 104, the monitoring component 110, the notification component 112, etc.). Repetitive description of like elements employed in other embodiments described herein is omitted for sake of brevity.

At 1002, the database component 104 can receive data (e.g., the data 106) associated with a first entity (e.g., a client entity and/or the client device 102) and one or more rules (e.g., the rules 108) defining use of the data by a second entity (e.g., the content sources 124). At 1004, the capturing component 202 can capture content (e.g., the content 404) communicated over a network (e.g., the networks 122) by the second entity (e.g., the content sources 124). At 1006, the extracting component 204 can extract one or more data entities from the content. At 1008, the logic component 206 can map the one or more data entities extracted from the content to one or more semantic entities. At 1010, the evaluating component 208 can match the one or more semantic entities to the data and/or the one or more rules.

At 1012, the monitoring component 110 can determine whether the content (e.g., the content 404) violates the one or more rules (e.g., the rules 108). If the content does not violate the one or more rules, the process 1000 proceeds back to 1004, wherein the monitoring component 110 and the respective associated components (e.g., the capturing component 202, the extracting component 204, the logic component 206, and the evaluating component 208) can repeat processing steps 1004 to 1012.

The grey box 1001 including processing steps 1004 to 1012 corresponds to an iterative sub-process of the process 1000. In this regard, processing steps 1004 to 1012 can be iteratively repeated until the decision at 1012 is a determination that the content (e.g., the content 404) violates the one or more rules (e.g., the rules 108). At this point, the process 1000 proceeds to 1014, wherein the notification component 112 can generate information indicative of one or more violations of the one or more rules.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed herein are capable of being stored on an article of manufacture to facilitate transporting and transferring such computer-implemented methodologies to computers. The term article of manufacture, as used herein, is intended to encompass a computer program accessible from any computer-readable device or storage media.

FIG. 11 illustrates a block diagram of an example, non-limiting operating environment 1100 in which one or more embodiments described herein can be facilitated. Repetitive description of like elements employed in other embodiments described herein is omitted for sake of brevity. In order to provide a context for the various aspects of the disclosed subject matter, FIG. 11 as well as the following discussion are intended to provide a general description of a suitable operating environment in which the various aspects of the disclosed subject matter can be implemented.

With reference to FIG. 11, an example of the operating environment 1100 for implementing various aspects of the claimed subject matter can include a computer 1102. The computer 1102 can include a processing unit 1104, a system memory 1106, a codec 1135, and a system bus 1108. The system bus 1108 can couple system components including, but not limited to, the system memory 1106 to the processing unit 1104. The processing unit 1104 can be any of various available processors. Dual microprocessors and other multiprocessor architectures also can be employed as the processing unit 1104.

The system bus 1108 can be any of several types of bus structure(s) including a memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1106 can include volatile memory 1110 and non-volatile memory 1112, which can employ one or more of the disclosed memory architectures, in various embodiments. The basic input/output system (BIOS), containing the basic routines to transfer information between elements within the computer 1102, such as during start-up, can be stored in non-volatile memory 1112. In addition, according to present innovations, codec 1135 can include at least one of an encoder or decoder, wherein the at least one of an encoder or decoder can consist of hardware, software, or a combination of hardware and software. Although, codec 1135 is depicted as a separate component, codec 1135 can be contained within non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 1112 can employ one or more of the disclosed memory devices, in at least some embodiments. Moreover, non-volatile memory 1112 can be computer memory (e.g., physically integrated with computer 1102 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 1110 can include random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1102 can also include removable/non-removable, volatile/non-volatile computer storage medium. FIG. 11 illustrates, for example, disk storage 1114. Disk storage 1114 can include, but is not limited to, devices like a magnetic disk drive, solid state disk (SSD), flash memory card, or memory stick. In addition, disk storage 1114 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1114 to the system bus 1108, a removable or non-removable interface can typically be used, such as interface 1116. It is appreciated that disk storage 1114 can store information related to an entity. Such information might be stored at or provided to a server or to an application running on an entity device. In one embodiment, the entity can be notified (e.g., by way of output device(s) 1136) of the types of information that can be stored to disk storage 1114 or transmitted to the server or application. The entity can be provided the opportunity to opt-in or opt-out of having such information collected or shared with the server or application (e.g., by way of input from input device(s) 1128).

It is to be appreciated that FIG. 11 describes software that can act as an intermediary between entities and the basic computer resources described in the operating environment 1100. Such software includes an operating system 1118. Operating system 1118, which can be stored on disk storage 1114, can act to control and allocate resources of the computer 1102. Applications 1120 can take advantage of the management of resources by operating system 1118 through program modules 1124, and program data 1126, such as the boot/shutdown transaction table and the like, that can be stored either in system memory 1106 or on disk storage 1114. It is to be appreciated that the claimed subject matter can be implemented with various operating systems or combinations of operating systems.

An entity can enter commands or information into the computer 1102 through input device(s) 1128. Input devices 1128 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 1104 through the system bus 1108 via interface port(s) 1130. Interface port(s) 1130 can include, for example, a serial port, a parallel port, a game port, and a universal serial bus (USB). Output device(s) 1136 can use some of the same type of ports as input device(s) 1128. Thus, for example, a USB port can be used to provide input to computer 1102 and to output information from computer 1102 to an output device 1136. Output adapter 1134 is provided to illustrate that there are some output devices 1136 like monitors, speakers, and printers, among other output devices 1136, which can require special adapters. The output adapter 1134 can include, by way of illustration and not limitation, video and sound cards that can provide a means of connection between the output device 1136 and the system bus 1108. It should be noted that other devices or systems of devices can provide both input and output capabilities such as remote computer(s) 1138.

Computer 1102 can operate in a networked environment using logical connections to one or more remote computers, such as remote computer(s) 1138. The remote computer(s) 1138 can be a personal computer, a server, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 can be logically connected to computer 1102 through a network interface 1142 and then connected via communication connection(s) 1144. Network interface 1142 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the system bus 1108. While communication connection 1144 is shown for illustrative clarity inside computer 1102, it can also be external to computer 1102. The hardware/software necessary for connection to the network interface 1142 can include, for exemplary purposes only, internal and external technologies such as, modems including regular telephone grade modems, cable modems and DSL modems, ISDN adapters, and wired and wireless Ethernet cards, hubs, and routers.

One or more embodiments can be a system, a method, and/or a computer program product at any possible technical detail level of integration. The computer program product can include a computer readable storage medium (or media) having computer readable program instructions thereon for causing a processor to carry out one or more aspects of the present embodiments.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the entity's computer, partly on the entity's computer, as a stand-alone software package, partly on the entity's computer and partly on a remote computer or entirely on the remote computer or server. In the latter scenario, the remote computer can be connected to the entity's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a database component that receives, from a first entity, data associated with the first entity and one or more rules defining use of the data by a second entity, wherein the data and the one or more rules are defined by the first entity;
a monitoring component that analyzes content communicated, over a network, by the second entity, to determine whether the content violates the one or more rules; and
a notification component that generates information indicative of one or more violations of the one or more rules based on a determination by the monitoring component that the content violates the one or more rules.

2. The system of claim 1, further comprising:
a storage component that stores the database component, wherein access to the database component is exclusive to the first entity.

3. The system of claim 1, wherein the one or more rules comprise:
one or more sensitivity levels associated with the data; and
one or more uses associated with the one or more sensitivity levels.

4. The system of claim 1, wherein the monitoring component comprises:
a capturing component that captures the content; and
an extraction component that extracts one or more data entities from the content.

5. The system of claim 1, wherein the monitoring component comprises:
a logic component that maps one or more data entities extracted from the content to one or more semantic entities.

6. The system of claim 1, wherein the monitoring component comprises:
an evaluating component that matches one or more semantic entities to at least one of the data and the one or more rules.

7. The system of claim 1, further comprising:
a specification component comprising one or more specifications defined by the first entity, wherein the monitoring component analyzes the content based on the one or more specifications.

8. A computer-implemented method, comprising:
receiving, by a system operatively coupled to a processor, from a first entity, data associated with the first entity and one or more rules defining use of the data by a second entity, wherein the data and the one or more rules are defined by the first entity;
analyzing, by the system, content communicated, over a network, by the second entity, to determine whether the content violates the one or more rules; and
generating, by the system, information indicative of one or more violations of the one or more rules based on a determination that the content violates the one or more rules.

9. The computer-implemented method of claim 8, further comprising:
storing, by the system, the data and the one or more rules, wherein access to the data and the one or more rules is exclusive to the first entity.

10. The computer-implemented method of claim 8, wherein the one or more rules comprise:
one or more sensitivity levels associated with the data; and
one or more uses associated with the one or more sensitivity levels, thereby facilitating at least one of improved processing accuracy and improved processing efficiency for automatic detection of unauthorized use of the data by the second entity.

11. The computer-implemented method of claim 8, wherein the analyzing comprises:
capturing, by the system, the content; and
extracting, by the system, one or more data entities from the content.

12. The computer-implemented method of claim 8, wherein the analyzing comprises:
mapping, by the system, one or more data entities extracted from the content to one or more semantic entities.

13. The computer-implemented method of claim 8, wherein the analyzing comprises:
matching, by the system, one or more semantic entities to at least one of the data and the one or more rules.

14. The computer-implemented method of claim 8, wherein the analyzing is based on one or more specifications defined by the first entity, thereby facilitating at least one of improved processing accuracy and improved processing efficiency for automatic detection of unauthorized use of the data by the second entity.

15. A computer program product that facilitates detecting unauthorized use of data associated with an entity, the computer program product comprising a computer readable storage medium having program instructions embodied therewith, the program instructions are executable by a processor to cause the processor to:
receive, from a first entity, data associated with the first entity and one or more rules defining use of the data by a second entity, wherein the data and the one or more rules are defined by the first entity;
analyze content communicated, over a network, by the second entity, to determine whether the content violates the one or more rules; and
generate information indicative of one or more violations of the one or more rules based on a determination that the content violates the one or more rules.

16. The computer program product of claim 15, wherein the program instructions further cause the processor to:
store the data and the one or more rules, wherein access to the data and the one or more rules is exclusive to the first entity.

17. The computer program product of claim 15, wherein the program instructions further cause the processor to:
capture the content; and
extract one or more data entities from the content.

18. The computer program product of claim 15, wherein the program instructions further cause the processor to:
map one or more data entities extracted from the content to one or more semantic entities.

19. The computer program product of claim 15, wherein the program instructions further cause the processor to:
match one or more semantic entities to at least one of the data and the one or more rules.

20. The computer program product of claim 15, wherein the program instructions further cause the processor to:
analyze the content based on one or more specifications defined by the first entity, thereby facilitating at least one of improved processing accuracy and improved processing efficiency for automatic detection of unauthorized use of the data by the second entity.
